(19) United States
(12) Patent Application Publication
(10) Pub. No.: US 2012/0248637 A1
(43) Pub. Date: Oct. 4, 2012

(54) METHODS AND DEVICES FOR MANUFACTURING AN ARRAY OF LENSES

(75) Inventors: Chao-Chi Chang, Suzhou Industrial Park (CN); Jean Pierre Lusinchi, Suzhou Industrial Park (CN)

(73) Assignee: ETHER PRECISION ,INC., Cayman Islands (KY)

(21) Appl. No.: 13/262,588

(22) PCT Filed: Apr. 3, 2011
(86) PCT No.: PCT/SG2009/000123

§ 371 Date: Dec. 8, 2011

(51) Int. Cl. B29D 11/00; B28B 7/24

(52) U.S. Cl. 264/2.5; 249/121

(57) ABSTRACT

The present technology relates generally to the manufacturing of optical lenses used in the fabrication of optical modules, such as for miniature camera, as the camera used in mobile phones. More particularly, the present technology relates to devices and methods for manufacturing arrays of lenses.

### BACKGROUND

The present technology relates generally to the manufacturing of optical lenses used in the fabrication of optical modules, such as for miniature camera, as the camera used in mobile phones. More particularly, the present technology relates to devices and methods for manufacturing arrays of lenses.

In order to reduce the cost of lenses and to allow massive volumes, in the range of several hundred thousand of modules per day in a single manufacturing site, one needs to develop a process to manufacture in parallel an array of several thousand of lenses. This array can then for example either be cut into individual lenses, or applied directly onto a wafer of image sensor for forming an array of complete camera.

Two examples of an optical lens are shown in FIGS. 1a and 1b.

FIG. 1a shows a lens 10 formed by a top layer 12 and a bottom layer 13 of an optical grade resin, such as epoxy, deposited on opposite surfaces a glass plate 14. A part 15 of the top surface of top layer 12 forms the top optical surface of the lens and has an optical axis 16. A part 17 of the bottom surface of bottom layer 13 forms the bottom optical surface of the lens and has an optical axis 18. Optical axes 16 and 18 must be aligned. The lens can be coupled with a light sensor 19 having a top transparent (for example glass) cover 20. A spacer 21, for example an etched glass plate or a molded plastic plate, separates the lens 10 from the surface of the sensor cover 20.

FIG. 1b shows an alternative embodiment where the lens is entirely made of an optical grade resin plate 22 having a top surface 23 and a bottom surface 24. A part 15 of the top surface 22 forms the top optical surface of the lens and has an optical axis 16. A part 17 of the bottom surface 24 forms the bottom optical surface of the lens and has an optical axis 18, which must be aligned with optical axis 16.

The lenses, such as illustrated in FIGS. 1a and 1b can be used to form a stacked structure such as shown in FIG. 1C. FIG. 1C shows a lens arrangement as illustrated in FIG. 1a, having on top a lens 10′ formed by a top layer 12′ and a bottom layer 13′ of an optical grade resin deposited on opposite surfaces a glass plate 14′. A part 15′ of the top surface of top layer 12′ forms the top optical surface of the lens and has an optical axis 16′. A part 17′ of the bottom surface of bottom layer 13′ forms the bottom optical surface of the lens and has an optical axis 18′. The lens 10′ is coupled with lens 10 using a spacer 21′, for example an etched glass plate or a molded plastic plate, which separates the lens 10′ from the lens 10. Optical axes 16′ and 18′ must be aligned together, and must be aligned with Optical axes 16 and 18.

Many publications have described ways of making an array of lenses, generally using a UV curable epoxy resin.

One known way of making an array of lenses such as illustrated in FIG. 1a or 1b comprises molding the array of lenses, with mold as dosely as possible complementary to the shape of the desired lens array.

A known way of manufacturing such mold involves generating a precise stamp having a shape identical to the top optical surface of the lenses of the array. A digitally controlled tool is then used to print in the surface of a soft material an array of negative shape complementary of the shape of the top surface of the desired array. The soft material is then hardened to form an upper half of the mold. A lower half of the mold is then manufactured using a stamp shaped as the bottom optical surface of the lenses of the array.

A problem with this known manufacturing process however is that even using a very precise digitally controlled tool for printing the surface of each half of the mold, the digitally controlled tool eventually introduces positioning errors that can be considered as random. Because of such positioning errors, the optical axes of the top and bottom surfaces of a random number of the lenses of the array are poorly aligned. Lens having poorly aligned optical axes of their top and bottom surfaces have poor performances, which is not desirable. A misalignment of a few micron degrades the resolution of the lens (measured by its Mean Transfer Function, or MTF) preventing it to use such lenses for an association with a sensor of about 1 Megapixels or more, in high volume production, as up to now the poor yield associated with a random misalignment of the axis makes production un economical.

The present technology provides for devices and methods that allow manufacturing arrays of lenses wherein the optical axes of the top and bottom surfaces of the lenses of the array are superiorly aligned.

### SUMMARY

As will be described in more detail hereinafter, an embodiment here described relates to a method of manufacturing an array of lenses, each lens of the array having a top optical surface that forms part of a top surface of the array, and a bottom optical surface that forms part of a bottom surface of the array; the top and bottom optical surface of each lens having first and second aligned optical axis, the method comprising:

making a master form having a top surface with a shape identical to the top surface of the lens array, including the top optical surface of each lens of the array; and a bottom surface with a shape identical to the bottom surface of the array, including the bottom optical surface of each lens of the array; wherein the parts of the master form that are identical to the top and bottom optical surface of each lens of the array have aligned first and second geometrical axes identical to the aligned first and second optical axes of the lenses; and

using the master form to produce a mold having a shape complementary to the shape of the array to be manufactured.

Another embodiment relates to a method of manufacturing an array of lenses; the array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned; the method comprising:

making a master form comprising:

a plate having a top surface and a bottom surface;

the top surface of the plate having a shape identical to the top surface of the array, including the top optical surface of each lens of the array; and

the bottom surface of the plate having a shape identical to the bottom surface of the array, including the bottom optical surface of each lens of the array; wherein

the parts of the top surface of the master form that are identical to the top optical surface of each lens of the array have first geometrical axes identical to the first optical axes, and the parts of the bottom surface of the master form that are identical to the bottom optical surface of each lens of the array have second geometrical axes identical to the second optical axes; the first and second geometrical axes being aligned; and

using the master form to produce a mold having a shape complementary to the shape of the array to be manufactured.

According to another embodiment, using the master form to produce a mold comprises:

forming an upper mold part having a bottom surface with a shape that is complementary to the shape of the top surface of the master form; and

forming a lower mold part having a top surface with a shape that is complementary to the shape of the bottom surface of the master form.

According to another embodiment, the bottom surface of the upper mold part comprises upper lens molding surfaces that are complementary to the top optical surface of the lenses of the array and the top surface of the lower mold part comprises lower lens molding surfaces that are complementary to the bottom optical surface of the lenses of the array; and the method further comprises: providing an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; such that the inner walls define, in combination with said groups of upper and lower lens molding surfaces, sub-molds capable of molding each a sub-array of lenses.

According to another embodiment, the method further comprises providing the upper mold part with first alignment holes and providing the lower mold part with second alignment holes; wherein:

forming a upper mold part having a bottom surface with a shape that is complementary to the shape of the top surface of the master form and forming a lower mold part having a top surface with a shape that is complementary to the shape of the bottom surface of the master form comprises aligning the first and second alignment holes.

According to another embodiment, the bottom surface of the upper mold part comprises upper lens molding surfaces that are complementary to the top optical surface of the lenses of the array and the top surface of the lower mold part comprises lower lens molding surfaces that are complementary to the bottom optical surface of the lenses of the array; and the method further comprises:

providing an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; such that the inner walls define, in combination with said groups of upper and lower lens molding surfaces, sub-molds capable of molding each a sub-array of lenses; and

providing the intermediary mold part with third alignment holes and aligning the third alignment holes with the first and second alignment holes.

According to another embodiment, the method further comprises providing the upper and lower mold parts with alignment means; wherein:

forming a upper mold part having a bottom surface with a shape that is complementary to the shape of the top surface of the master form and forming a lower mold part having a top surface with a shape that is complementary to the shape of the bottom surface of the master form comprises aligning the alignment means of the upper and lower mold parts.

Another embodiment relates to a method of manufacturing an array of lenses; the array of lenses having a top surface and a bottom surface; each lens of the array having a top optical surface that forms part of the top surface of the array, and a bottom optical surface that forms part of the bottom surface of the array; the method comprising:

making a mold part comprising:

a plate having a top surface and a bottom surface;

the top surface of the plate having a shape complementary to the bottom surface of the array, including the bottom optical surface of each lens of the array; and

the bottom surface of the plate having a shape complementary to the top surface of the array including the top optical surface of each lens of the array; wherein

the parts of the top surface of the mold part that are complementary to the bottom optical surface of each lens of the array have first geometrical axes identical to the first optical axes, and the parts of the bottom surface of the mold part that are complementary to the top optical surface of each lens of the array have second geometrical axes identical to the second optical axes; the first and second geometrical axes being aligned.

Another embodiment relates to a master form for manufacturing a mold for manufacturing an array of lenses; the array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned;

the master form comprising:

a plate having a top surface and a bottom surface;

the top surface of the plate having a shape identical to the top surface of the array, including the top optical surface of each lens of the array; and

the bottom surface of the plate having a shape identical to the bottom surface of the array, including the bottom optical surface of each lens of the array; wherein

the parts of the top surface of the master form that are identical to the top optical surface of each lens of the array have first geometrical axes identical to the first optical axes, and the parts of the bottom surface of the master form that are identical to the bottom optical surface of each lens of the array have second geometrical axes identical to the second optical axes; the first and second geometrical axes being aligned.

According to another embodiment, the master form is not transparent to light.

According to another embodiment, the array comprises lenses arranged along a two-dimensional pattern.

According to another embodiment, the plate further comprises alignment holes.

Another embodiment relates to a mold manufactured using the previous master form, the mold comprising:

an upper mold part having a bottom surface with a shape that is complementary to the shape of the top surface of the master form; and

a lower mold part having a top surface with a shape that is complementary to the shape of the bottom surface of the master form.

According to another embodiment, the bottom surface of the upper mold part comprises upper lens molding surfaces that are complementary to the top optical surface of the lenses of the array and the top surface of the lower mold part comprises lower lens molding surfaces that are complementary to the bottom optical surface of the lenses of the array; the mold further comprising: an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; the inner walls being arranged to define, in combination with said groups of upper and lower lens molding surfaces, sub-molds capable of molding each a sub-array of lenses.

Another embodiment relates to a mold manufactured using the previous master form that has a plate with alignment holes, the mold comprising:

an upper mold part having a bottom surface with a shape that is complementary to the shape of the top surface of the master form; and

a lower mold part having a top surface with a shape that is complementary to the shape of the bottom surface of the master form; wherein

the upper and lower mold parts comprise alignment holes that are aligned with the alignment holes of the master form.

According to another embodiment, the bottom surface of the upper mold part comprises upper lens molding surfaces that are complementary to the top optical surface of the lenses of the array and the top surface of the lower mold part comprises lower lens molding surfaces that are complementary to the bottom optical surface of the lenses of the array; the mold further comprising:

an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; the inner walls being arranged to define, in combination with said groups of upper and lower lens molding surfaces, sub-molds capable of molding each a sub-array of lenses; and

alignment holes capable of being aligned with the alignment holes of the upper and lower mold parts.

Another embodiment relates to a mold manufactured using the previous master form, the mold comprising:

an upper mold part having a bottom surface with a shape that is complementary to the shape of the top surface of the lens array; the bottom surface of the upper mold part having upper negative lens shapes complementary to the top optical surface of each lens of the array; the upper negative lens shape having third geometrical axes identical to the first optical axes; and

a lower mold part having a top surface with a shape that is complementary to the shape of the bottom surface of the lens array; the top surface of the lower mold part having lower negative lens shapes complementary to the bottom optical surface of each lens of the array; the lower negative lens shape having fourth geometrical axes identical to the second optical axes; wherein

the upper and lower mold parts comprise alignment means for arranging the upper and lower mold parts with respect to each other such that the third and fourth geometrical axes are aligned.

Another embodiment relates to a mold manufactured using the previous master form, wherein the master form comprises alignment means, and wherein the alignment means of the upper and lower mold parts cooperate with the alignment means of the master form for arranging the upper and lower mold parts with respect to the master form such that the first, second, third and fourth geometrical axes are aligned together.

Another embodiment relates to a mold part for manufacturing an array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned;

the mold part comprising:

a plate having a top surface and a bottom surface;

the top surface of the plate having a shape complementary to the bottom surface of the array, including the bottom optical surface of each lens of the array; and

the bottom surface of the plate having a shape complementary to the top surface of the array including the top optical surface of each lens of the array; wherein

the parts of the top surface of the mold part that are complementary to the bottom optical surface of each lens of the array have first geometrical axes identical to the first optical axes, and the parts of the bottom surface of the mold part that are complementary to the top optical surface of each lens of the array have second geometrical axes identical to the second optical axes; the first and second geometrical axes being aligned.

Another embodiment relates to the realization of a master form composed of a base, and cores whose upper and lower surfaces are a positive model of the Optical Surfaces of the elementary lenses, each core being itself a replica of a single master core. The replication of the cores is done by a molding process accurate enough to not introduce a significant difference between the cores. The alignment of the optical axis of all the cores is the same as the alignment of the ones in the master core. The cores are a positive model of the lens to be realized in array form.

Another embodiment relates to the realization of the two molds of the upper and lower surface in one single operation by thermoforming a plastic material, for example belonging to the family known as Elastomers, each between a rigid plate, for example in metal having a predetermined coefficient of thermal expansion, and the corresponding surface of the master form. The alignment of all the axis of the upper and lower surfaces is the same as the one of the cores. The alignment of the plates and of the Master mold is done by using centering pins and holes, as it is of standard practice in the technology of making molds. When the master form is removed, the same mechanical alignment of the two parts of the mold can be reproduced using the centering holes and centering pins.

Another embodiment relates to the realization of the Lens Array in one single operation by thermoforming or thermosetting an appropriate plastic material, for example a thermo curing epoxy resin having the desired optical transparency, refractive index and Abbe number, in the cavity formed by the two molds of the upper and lower surfaces, positioned such as to have the proper spacing. The usage of the alignment pins and holes insure the same mechanical alignment of the upper and lower surfaces as during the realization of the molds, so that the alignments of the optical axis of the upper and lower surfaces of each lens are the same as the alignments of the corresponding surfaces in the mold, which themselves reproduce the alignments of the surfaces of the cores in the master form.

Another embodiment relates to the realization of the Lens Array in two operations, when the array of lenses is composed of a glass body and an upper and lower layer of resin having the appropriate shape to form an optical lens. The plate of glass used to make the glass body of the lens Array is mounted into a frame having the same alignment holes as the molds. First, the mold of one of the surfaces is positioned using the alignment pins and holes; a thin layer of resin is molded then cured between the glass and the mold, so forming one of the Optical Surface of the Lens Array. Second, the operation is repeated, this time using the mold of the other surface, and the other surface the plate of glass. During all these operations, the mechanical position of the molds and of the glass plate is defined by the centering holes and pins, so that the alignments of the optical axis of the upper and lower surfaces of each lens are the same as the alignments of the corresponding surfaces in the mold, which themselves reproduce the alignments of the surfaces of the cores in the master form.

Another embodiment of the present invention relates to the realization of molds from a master form, the realization of molds in a form of an array of cores embedded into a base, each core being a negative model of the lens to be realized in array form. Both the base and the cores are done in a material with anti sticking properties, like the PTFE, or in any other material coated at the time of the molding with an appropriate anti sticking agent. The cores are either machined, or molded. The base is composed of two plates, and the shape of the cores allow a locking into the two plates as well as an easy unlocking and replacement of the defective ones. The mechanical position of the base is defined using centering holes. The two faces of the mold are used successively to mold the upper and lower Optical Surfaces of a Lens Array with a glass body. During all these operations, the mechanical position of the mold and of the glass plate is defined by the centering holes and pins, so that the alignments of the optical axis of the upper and lower surfaces of each lens are the same as the alignments of the corresponding surfaces in the mold, which themselves reproduce the alignments of the surfaces of the cores in the master form.

### BRIEF DESCRIPTION OF THE DRAWINGS

FIG. 1A shows a lens made of a glass plate with layers of resin on each of its side.

FIG. 1B shows a lens is entirely made of resin.

FIG. 1C shows a stacked structure formed of two lenses.

FIG. 2 is an elevation view of a master form according to the invention.

FIG. 3 is a cross-section view of the master form of FIG. 2.

FIG. 4 is an elevation view of a preferred master form according to the invention.

FIG. 5 is a cross-section view of the preferred master form of FIG. 2.

FIG. 6 shows a cross section of a mold for manufacturing a lens form as shown in FIG. 5.

FIGS. 7 and 8 illustrate in cross-section the manufacturing of a mold according to a preferred embodiment of the invention.

FIGS. 9A-B illustrate in cross-section the manufacturing of a lens array with the mold of FIG. 8.

FIG. 10 illustrates in cross-section the addition of a spacer to one lens of a lens array such as manufactured as in FIGS. 9A-B.

FIG. 11 illustrates in cross-section a mold part 110 according to another embodiment of the invention.

FIG. 12 illustrates an elevation view of an additional mold part that can be used with a mold made according to the invention.

FIG. 13 is a cross-section view of a mold such as in FIG. 8, with the additional mold part of FIG. 12.

FIG. 14 is an upper view of a sub-arrays of four lenses that can be manufactured by a mold as shown in FIG. 13.

### DETAILED DESCRIPTION OF THE PREFERRED EMBODIMENTS

Referring initially to FIG. 2, a preferred embodiment will now be described.

The preferred embodiment provides for molding an array of lenses in an appropriate material with a “negative” mold, obtained from a positive master form. This technique of forming the mold from a master form allows renewing as much as necessary the mold, if the latter gets worn out after multiple molding operations. The mold preferably comprises an upper mold and a lower mold, as detailed hereafter.

In the preferred embodiment, the master form has a shape substantially identical to the shape of the desired lens array. The mold has substantially a shape complementary to the shape of the desired lens array.

FIG. 2 shows an elevation view of the top surface of a master form 20. The master form 20 comprises a plate 22. The top surface of the plate has a shape substantially identical to the top surface of the desired lens array. The top surface of the plate comprises in particular parts 24 that are identical to the top optical surface of each lens of the desired lens array. The bottom surface of the plate (not illustrated in FIG. 2) has a shape substantially identical to the bottom surface of the desired lens array, and it comprises in particular parts that are identical to the bottom optical surface of each lens of the desired lens array.

As detailed hereafter, the master form 20 preferably comprises alignment means such as alignment holes 26.

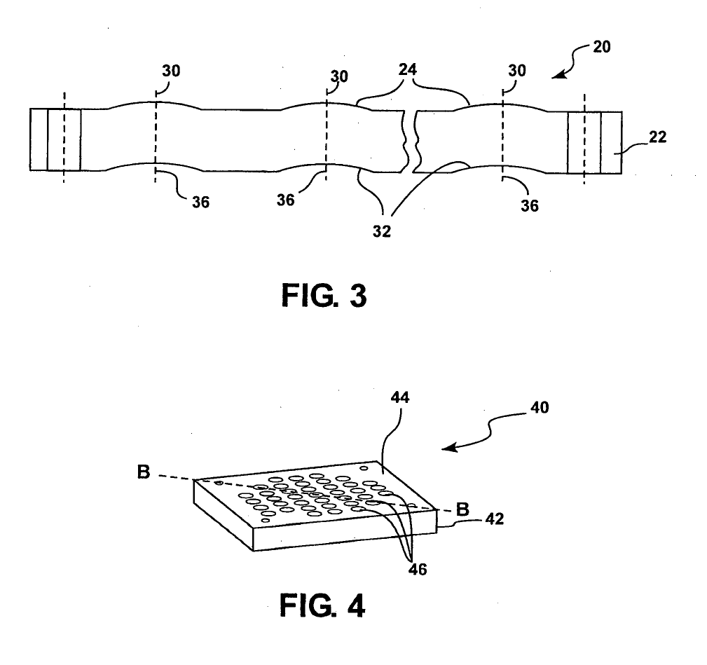

FIG. 3 is a cross-section view of the master form 20 of FIG. 2, taken along the line A-A shown in FIG. 2. The parts 24 of the master form identical to the top optical surface of the lenses of the array have first geometrical axes 30 that are identical to the optical axes of the top optical surface of the lenses. Similarly, the parts 32 of the bottom surface of the master form that are identical to the bottom optical surface of each lens of the array have second geometrical axes 36 identical to the optical axes of the bottom optical surface of the lenses. The master form 20 is manufactured such that the first and second geometrical axes 30 and 36 are aligned. The master form can be manufactured as a monolithic piece, or by assembling a plurality of parts, as described hereafter with respect to a preferred master form.

In the present application, having axes aligned means that the axes are parallel with an error of less than 0.5 degree and preferably less than 0.1 degree; and that the intersection points of the axes with a plane perpendicular to the axes are distant of less than 5 microns and preferably less than 3 microns (axes distant of less than 5 microns and preferably less than 3 microns). The present invention allows having axes distant of one micron or less.

FIG. 4 shows an elevation view of the top surface of a preferred master form 40. The master form 40 comprises a plate 42. The top surface 44 of the plate 42 has a shape substantially identical to the top surface of the desired lens array. The top surface 44 of the plate comprises in particular parts 46 that have a shape identical to the top optical surface of each lens of the desired lens array. The bottom surface of the plate (not illustrated in FIG. 4) has a shape substantially identical to the bottom surface of the desired lens array, and it comprises in particular parts that have a shape identical to the bottom optical surface of each lens of the desired lens array.

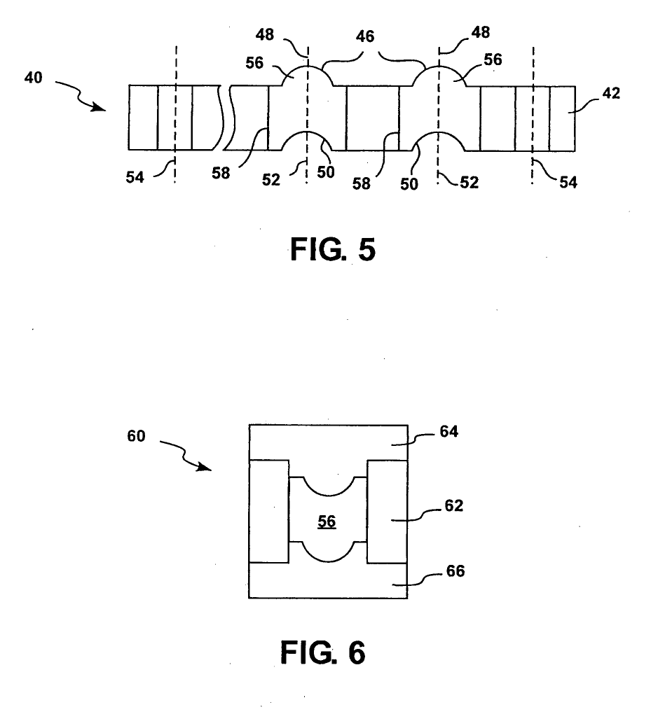

FIG. 5 is a cross-section view of the master form 20 of FIG. 4, taken along the line B-B shown in FIG. 4. The parts 46 of the master form with a shape identical to the top optical surface of the lenses of the array have first geometrical axes 48 that are identical to the optical axes of the top optical surface of the lenses. Similarly, the parts 50 of the bottom surface of the master form with a shape identical to the bottom optical surface of each lens of the array have second geometrical axes 52 identical to the optical axes of the bottom optical surface of the lenses. The master form 40 preferably comprises alignment means such as alignment holes 54.

In a preferred embodiment, the master form 40 is comprised of a plurality of lens forms 56 having each a top part 46 identical to the top optical surface of a lens of the array and a bottom part 50 identical to the bottom optical surface of a lens of the array. Each lens form 56 is disposed in a through-hole 58. Preferably, through-holes 58 are cylindrical and lens forms 56 have lateral walls that follow a cylinder; and through-holes 58 are concentrically aligned with lens forms 56. Positioning the lens forms 56 into the through-holes 58 can involve placing plate 42 on a plane substrate, introducing the lens forms 56 into the through-holes 58 until the lens forms 56 touch the plane substrate, and then gluing the lens forms 56 into place. The plate 42 is then separated from the substrate. The plate 42 can be a metal plate. Through-holes 58 can for example be made by drilling or by Electro Discharge Machining, or by any appropriate means that gives the necessary accuracy.

FIG. 6 shows a cross section of a lens form mold 60 for manufacturing a lens form 56. Lens form mold 60 comprises a central mold part 62 having inner walls complementary to the lateral walls of the lens form. An upper mold part 64 comprises a bottom surface having a shape complementary to the bottom optical surface of the lens form. A lower mold part 66 comprises a top surface having a shape complementary to the top optical surface of the lens form.

The dimensions and shapes of the master form, and in particular of the lens forms when the master form uses lens forms as illustrated in FIG. 5, are calculated with respect to the desired optical properties of the lenses of the array and with respect to the optical properties of the material that will ultimately be used to mold the array of lens. Because the material that is ultimately used to mold the array of lens, such as some optical grade epoxy resins, can have insufficient mechanical properties (i.e. be not strong enough or not stable enough) for making a master form that lasts long, other stronger or more stable replacement materials, such as molded glass or ceramic or metal, can be used to manufacture the lens forms. It must be pointed out that even if the replacement material used for making the lens forms is transparent (as in the case of glass used instead of an epoxy resin), the refractive indexes of the replacement material generally differ from the refractive indexes of the material actually used for manufacturing the array of lenses. In such a case the lens forms will not have the same properties as the lenses of the array and the master form will not have the same optical properties as the desired lens array. Of course, if the replacement material used for making the lens forms is opaque to light, the master form will also not have the same optical properties as the desired lens array.

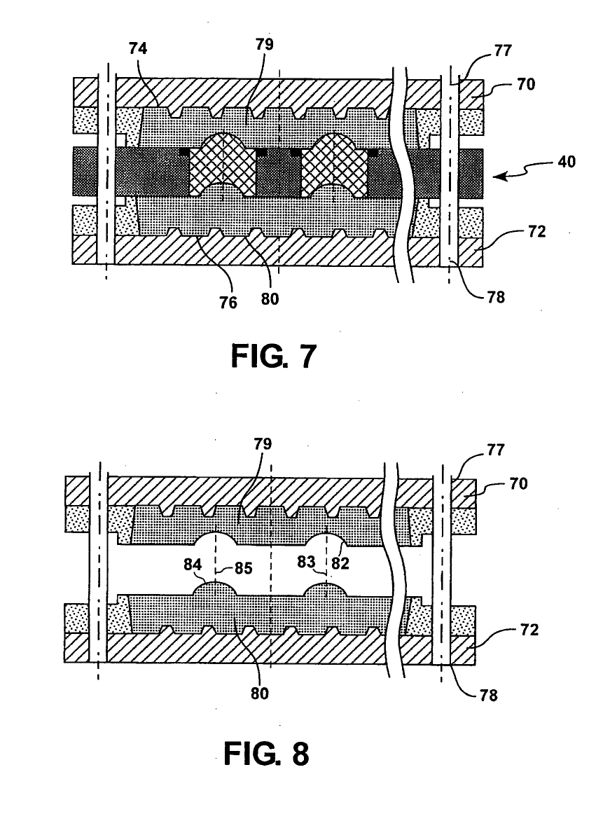

FIG. 7 illustrates in cross-section the manufacturing of a mold according to a preferred embodiment of the invention. The master form 40 is disposed between an upper mold base 70 and a lower mold base 72 such that upper and lower mold cavities 74, 76 are formed above and below the master form. Importantly, upper mold base 70 and lower mold base 72 comprise alignment means such as alignment holes 77, 78, respectively. Alignment holes 77 and 78 allow positioning upper mold base 70 with respect to lower mold base 72 with a desired precision and in a reproducible manner. As detailed above, master form 40 preferably comprises alignment holes 54. In such case, alignment holes 54, 77 and 78 also allow positioning master form 40 with respect to upper mold base 70 and lower mold base 72 with a desired precision and in a reproducible manner. Centering pins (not shown) can be used to align the alignment holes.

A mold material such as plastic (for example of the dimethyl siloxane family of plastics known as “elastomers”) is then injected or otherwise introduced into upper and lower mold cavities 74, 76 to form an upper mold part 79 and a lower mold part 80. Preferably, the surfaces of the master form will have been coated with an anti sticking agent, for example one of the family of the tricholorosilanes, but not the surfaces of the submold bases, so that the elastomer will adhere to the bases, but not to the master form.

FIG. 8 shows in cross-section the upper mold base 70, holding upper mold part 79, and lower mold base 72, holding lower mold part 80, after master form 40 was removed. Together, upper mold part 79 and lower mold part 80 form a negative shape of the master form 40. The faces of the mold parts forming the negative shape of the master form can be coated with an anti sticking agent, such as a trichiorosilane.

Alignment holes 77 and 78 allow positioning upper mold part 79 with respect to lower mold part 80 with a desired precision and in a reproducible manner. The bottom surface of upper mold part 79 has a shape complementary to the top surface of the lens array, including shapes 82 complementary to the top optical surface of each lens of the array. Shapes 82 (or upper lens molding surfaces 82) have geometrical axes 83 identical to the geometrical axes 48 of the master form and thus identical to the optical axes of the corresponding top optical surfaces of the lenses. Similarly, the top surface of lower mold part 80 has a shape complementary to the bottom surface of the lens array, including shapes 84 complementary to the bottom optical surface of each lens of the array. Shapes 84 (or lower lens molding surfaces 84) have geometrical axes 85 identical to the geometrical axes 52 of the master form and thus identical to the optical axes of the corresponding bottom optical surfaces of the lenses.

Taking a negative shape of the top surface of master form 40 with upper mold part 79 effectively positions the geometrical axes 83 with respect to alignment holes 77. Also, taking a negative shape of the bottom surface of master form 40 with lower mold part 80 effectively positions the geometrical axes 85 with respect to alignment holes 78. Because geometrical axes 83 and 85, which are identical to the geometrical axes 48, 52 of master form 40, are aligned when geometrical axes 83, 85 are positioned with respect to alignment holes 77, 78, which are themselves aligned with the desired precision, the geometrical axes 83 can be aligned with the geometrical axes 85 with the desired precision whenever alignment holes 77, 78 are aligned. Advantageously, alignment holes 54 in master form 40 allow positioning geometrical axes 83 and 85 in a precise predetermined way with respect to alignment holes 77, 78.

In other words, the geometrical axis of the shapes of the mold parts that correspond to the optical surfaces of the array lenses (mold negative optical cavities) are mechanically referenced to the position of the alignment holes when taking the print of the master form, and this reference is kept when the master form is removed. So, the position of the optical axis of the lenses have been accurately reproduced in all the negative optical cavities of the mold.

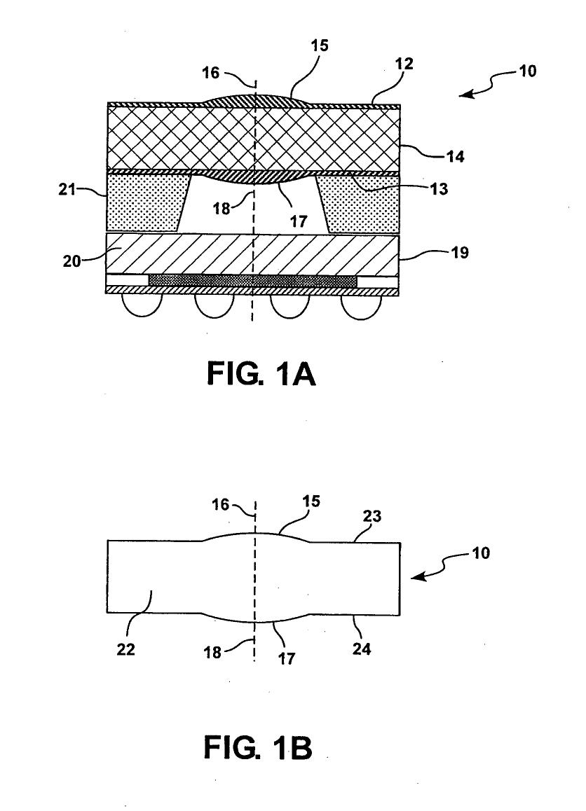

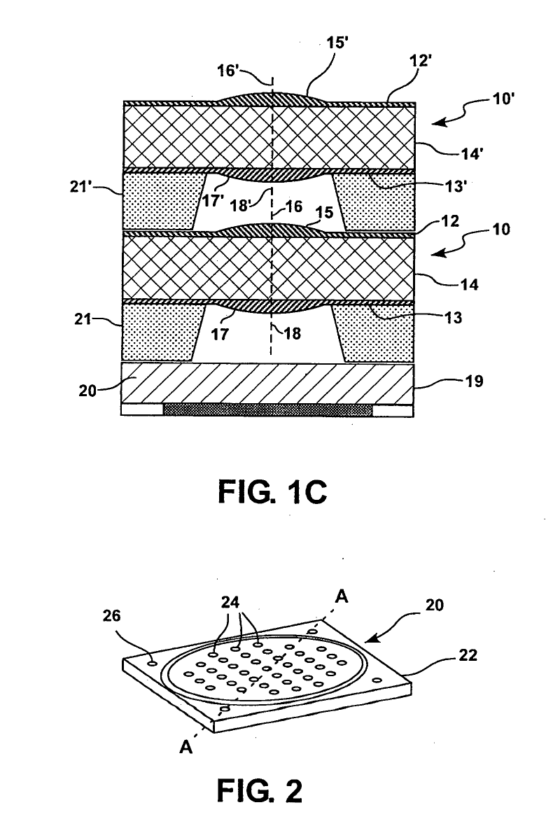

An array of lenses such as shown in FIG. 1B, can then be produced by dispensing for example a thermocurable optical grade epoxy resin into the cavity formed between the upper and lower mold parts. Such an array of lenses will comprise alignment holes corresponding to the alignment holes of master form 40.

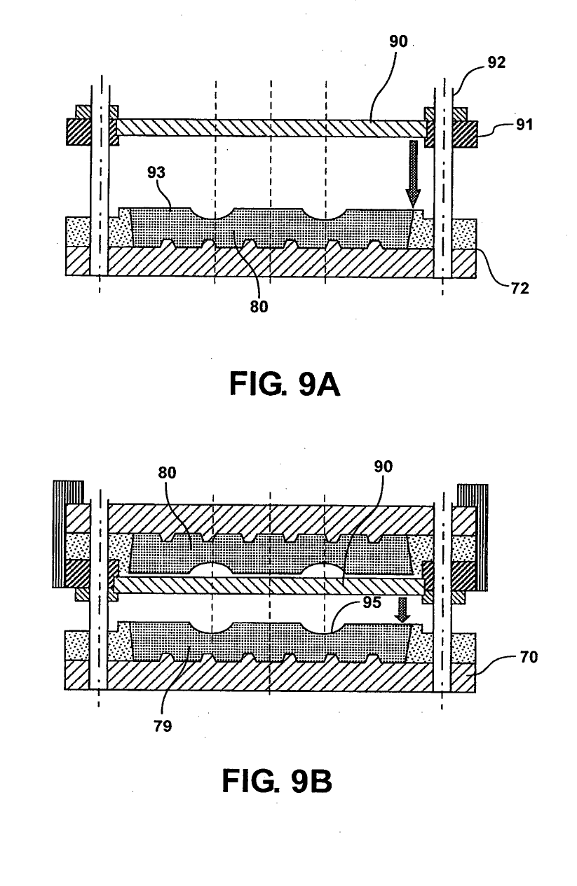

FIGS. 9A-B illustrate in cross-section the manufacturing of an array of lenses such as shown in FIG. 1a with the mold of FIG. 8. A glass plate 90 having appropriate optical characteristics is placed into a holder 91 having alignment holes 92 allignable with lower mold part 80 using alignment holes 78 of lower mold base 72. Glass plate 90 can be coated with a stack of metallic oxyde layers, for example to form an Infrared Cut Filter (IRCF).

As shown in FIG. 9A, a thin layer 93 of appropriate material, such as optical grade epoxy resin, is dispensed on top surface of lower mold part 72, and then glass plate 90 into holder 91 is aligned with lower mold part 80 using alignment holes 78 of lower mold base 72, and pressed on the mold.

As shown in FIG. 9B, a thin layer 95 of appropriate material, such as optical grade epoxy resin, is dispensed on the upper mold base 70 with upper mold part 79 put upside-down, and the assembly comprising aligned glass plate 90 and lower mold part 80 is aligned upside down with upper mold part 79 and lowered such that glass plate 90 is pressed onto layer 95.

The assembly comprising aligned glass plate 90 and molds part 79, 80, is placed into an oven (not shown) and the appropriate material, such as an optical grade epoxy resin, is thermally cured to form an array of lenses such as shown in FIG. 1A. The cured array can be removed from the mold.

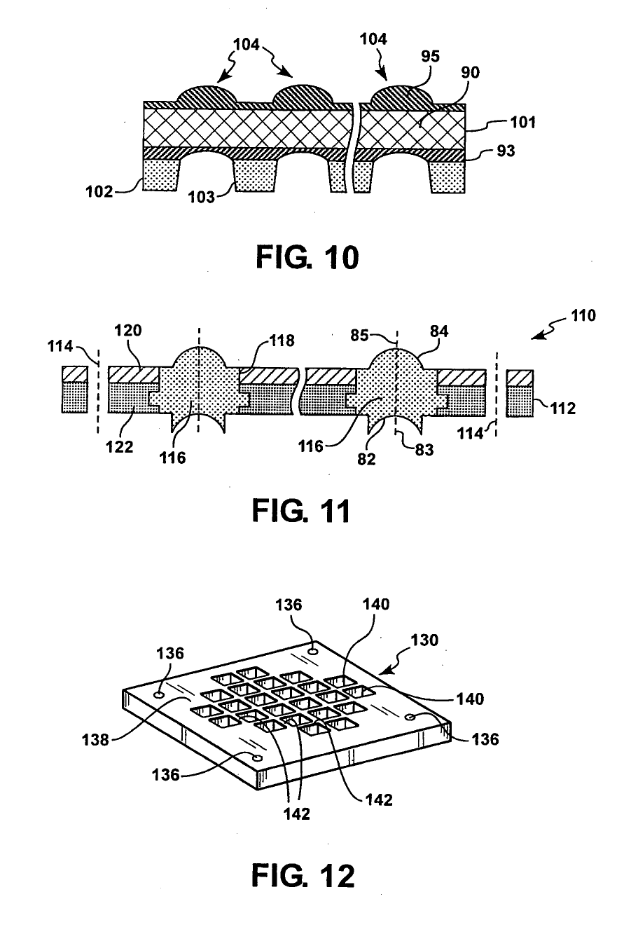

FIG. 10 illustrates in cross-section the addition of a spacer to one lens of a lens array 101 such as manufactured as in FIGS. 9A-B. The spacer is for example a glass plate 102, the top surface of which is assembled to the bottom surface of lens array 101. A through hole 103 in plate 102 corresponds to each lens 104 of array 101. Through hole 103 is preferably of a circumference larger than the circumference of its corresponding lens 104, and is preferably concentrically aligned with its corresponding lens. Through holes 103 can be made by appropriate means, such as sand blasting. The sand blasting technique gives the sides of through holes 103 a slope, generally not steeper than 70 deg measured from the surface of plate 102, or in other terms, smaller than 30 degree from the perpendicular to this surface. This slope measured from the perpendicular to the surface is preferably larger than the Maximum Chief Ray Angle of the lens 104, which is preferably smaller than 30 degrees. The position of the hole 103 with respect to the optical axis of lens 104 is not critical; the sole function of the spacer is to provide an accurate spacing between the lens and the cover glass of a sensor array (not illustrated in FIG. 10) that can be assembled to the bottom surface of the spacer. The accuracy of the spacing is given by the accuracy in the thickness of the glass plate 102, which can be as small as 5 microns. The glass plate 102 can be assembled to such sensor array using thermo curable glue. Positioning of the lens array with its spacer with respect to such sensor array can be done using a technique such as fiducial marks. The accuracy of such alignment is not critical, as the positioning can be done with a tolerance of 20 microns.

The top or lower surface of the spacer can be coated with a black material, metallic oxide or paint.

The aperture of the lenses of a lens array manufactured according to the present invention can be defined by a layer of black resin disposed on the top surface of the array. Such black resin can be of the UV sensitive type. The resin is first spread onto the entire surface of the array of lenses, and then a mask opaque to UV with holes matching exactly the dimension of the lens aperture is placed onto it, and the resin is exposed to UV light. The area exposed with UV is soluble in appropriate solvent, and can be so removed, making an accurate definition of the lens aperture.

Alternatively, when the lens array is manufactured using a glass plate such as illustrated in FIGS. 9A-B, the apperture of the lenses can be defined by covering a surface of the glass plate with an opaque layer, wherein the opaque layer is removed along disk patterns circumferencially aligned with the optical axis of the lenses' optical surfaces formed on the surface of the glass plate.

FIG. 11 illustrates in cross-section a mold part 110 according to another embodiment of the invention for manufacturing a lens array (not shown) having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned.

Mold part 110 comprises a plate having a top surface and a bottom surface. The top surface of plate 112 has a shape complementary to the bottom surface of the array, including parts 84 complementary to the bottom optical surface of each lens of the array. The parts 84 of the top surface of the mold part 110 that are complementary to the bottom optical surface of each lens of the array have geometrical axes 85 identical to the optical axes of the corresponding lens' bottom optical surface.

The bottom surface of the plate 112 has a shape complementary to the top surface of the array, including parts 82 complementary to the top optical surface of each lens of the array. The parts 82 of the bottom surface of the mold part 110 that are complementary to the top optical surface of each lens of the array have geometrical axes 83 identical to the optical axes of the corresponding lens' top optical surface.

Mold part 110 comprises alignment means such as alignment holes 114. Preferably, mold part 110 is comprised of a plurality of negative lens forms 116 having each a top part 84 complementary to the bottom optical surface of a corresponding array lens, with a geometrical axis 85. Negative lens form 116 also has a bottom part 82 complementary to the top optical surface of a corresponding lens of the array, with a geometrical axis 83. Each lens form 116 is disposed in a through-hole 118. Preferably, through-holes 118 comprise a sequence of concentrically aligned cylindrical walls complementary of the lateral walls of negative lens forms 116 such that negative lens forms 116 are locked in a predetermined position within through-holes 118. In FIG. 11, plate 112 is comprised of an upper plate 120 and a lower plate 122 comprising respectively upper and lower halves of through-hole 118. Plates 120, 122 and/or negative lens forms 116 can be made of metal, or of a plastic with a very low adhesion such as Polytetrafluorethylene (PTFE), either by machining techniques or by molding, or by molding in a heat resistant plastic like Liquid Crystal Polymer (LCP). In this later case, a coating with anti sticking agent will preferably be used.

The thickness of mold part 110, and in particular of plate 112, is not critical. This allows making plate 112 thick enough to be very rigid, and also to make plate 112 in two parts 120, 122 in order to provide a way to lock the negative lens forms 116. The negative lens forms 116 are preferably removable once plates 120, 122 are separated, so that they can be individually removed from mold part 110 to be replaced when they are damaged.

The two faces of mold part 110 can be successively used in replacement of lower mold part 80 and upper mold part 79 to mold lens arrays as described in relation to FIGS. 9A-B. Mold part 110 must be precisely aligned with the array of lenses and the mold supports, for example using alignment holes 114.

A mold such as shown in FIG. 8 allows manufacturing in a single molding step a lens array comprising a large number of lenses. However, some applications require the use of a sub-array of lenses, comprising for example four lenses only. Manufacturing sub-array of lenses from a large lens array requires dicing the lens array. Even assuming that such dicing operation can be conducted without damaging the lenses, a dicing operation can be time-consuming. It is therefore desirable to find a way to manufacture sub-array of lenses without having to conduct a time-consuming dicing operation.

FIG. 12 is an elevation view of an additional intermediary mold part 130 that can advantageoulsy be used in combination with a mold such as shown in FIG. 8 to manufacture sub-array of lenses. Intermediary mold part 130 has substantially the size and thickness of a lens array as would be manufactured using the mold of FIG. 8 alone. Intermediary mold part 130 preferably comprises alignment holes 136 identical to the alignment holes the lens array would have. Intermediary mold part 130 comprises a plate 138 pierced with a plurality of see-through holes 140 separated by inner walls 142, as detailed hereafter.

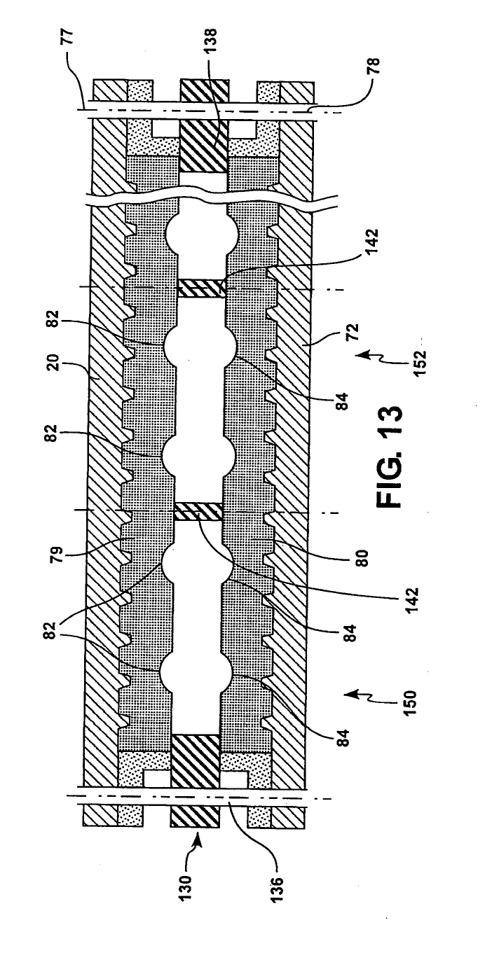

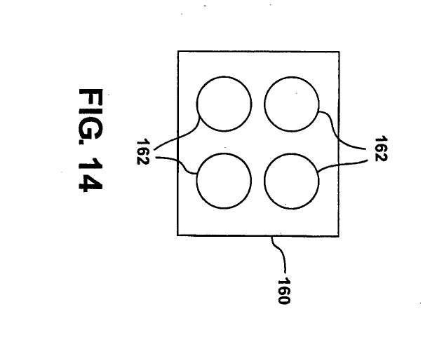

FIG. 13 is a cross-section view of intermediary mold part 130 positioned in a mold such as shown in FIG. 8. Plate 138 and inner walls 142 are arranged such that they define, in combination with the upper and lower mold parts 79, 80, distinct sub-molds 150, 152, 154 comprising each a reduced number of lens molding surfaces. The mold cavities of sub-molds 150, 152, 154 are separated from each other by inner walls 142. If Intermediary mold part 130 comprises alignment holes 136, alignment holes 136 can be aligned with holes 77, 78 of the upper and lower mold parts.

Inner walls 142 are made such that they are capable of contacting the bottom surface of the upper mold part along predetermined perimeters between groups of upper lens molding surfaces 82; and capable of contacting the top surface of the lower mold part along predetermined perimeters between corresponding groups of lower lens molding surfaces 84; the inner walls being arranged to define, in combination with said groups of upper and lower lens molding surfaces, sub-molds capable of molding each a sub-array of lenses. Filling the mold cavities of sub-molds 150, 152, 154 with the appropriate lens material, such as a resin, allows forming in a single molding operation a number of sub-arrays comprising each a reduced number of lenses per sub-mold. The shape of the sub-array of lenses, as well as the number of lenses per sub-array of lenses depend on the arrangement of the inner walls 142 of intermediary mold part 130.

Advantageously, the upper and lower mold parts 79, 80 and the intermediary mold part 130 can be arranged to manufacture sub-arrays 160 of four lenses 162 as shown in FIG. 14. Advantageously, the four lenses can have distinct sizes and shapes, so that each of the four lens has similar optical properties for distinct light wavelengths.

Eventually, an upper surface or lower surface of inner walls 142 can be provided with recesses arranged to form small apertures between the sub-molds. Such recesses will eventually fill with material and form links between the sub-arrays when molding the sub-arrays of lenses. Advantageously, the recesses are shaped so that the links can be easily separated from the sub-arrays of lenses after molding.

Alternatively, intermediary mold part 130 can be replaced by modifying either of the upper and lower mold parts 79, 80 such that they include walls identical to inner walls 142, or by modifying both the upper and lower mold parts 79, 80 such that they include each walls identical to half the inner walls 142.

The embodiments described above were described as examples only. Therefore, the present examples are to be considered as illustrative and not restrictive, and the invention is not to be limited to the details given herein, but may be modified within the scope of the appended claims. Numerous variations and alternatives can be made to the described embodiments, and still be part of the present invention.

The master form of FIG. 5 is described as being formed from a single plate. The “plate” can be comprised of a plurality of elements if appropriate, substantially as the plate of FIG. 11. The plate of the master form allows maintaining the alignment between the geometrical axes of the parts of the bottom & top surface that are identical to the top & bottom optical surface of each lens of the array.

The “plate” of the master form is described as generally following a plane, but not necessarily. The present invention allows manufacturing lens arrays with a plate that is not plane, but for example follows a sphere cap, or follows a plurality of plane surfaces angled with respect to each other.

The lenses of the array can be disposed with respect to each others along a two-dimensional pattern that is for example an array having more than one row and more than one column. However, the lenses of the array can be disposed along triangles, spirals, concentric circles, etc . . . .

Where the application uses the term “aligned”, it is meant aligned with a predetermined precision that is sufficient for the desired array of lenses.

The description is made in relation with molding. The present invention can however be used with other manufacturing processes, such as stamping or embossing, if appropriate. The term “mold” in the present application generally applies to a negative form having a shape complementary to the shape of the array to be manufactured, that can be used for manufacturing the array by a molding process or another process that can use such negative form, such as a stamping or embossing process.

The master form has preferably the same thickness as the desired lens array. This allows for example forming upper and lower mold from master form in a single step. However, the master form can also have a thickness different from the thickness of the desired lens array. In such case, upper and lower mold can be formed from the master form in successive steps.

The lens arrays illustrated in the present application are only examples. The present invention allows manufacturing lens arrays having lenses with any combination of concave or convex optical surface. Also, the lens arrays illustrated in the application are comprised of identical lenses, but the present invention allows manufacturing lens arrays comprised of lenses having different optical characteristics, arranged along any predetermined pattern.

The dimensions of the master form are calculated with respect to the optical properties of the material that will ultimately be used to mold the array of lens. It follows that an array of lenses having lenses made in a material with optical properties different from the optical properties of the material used to mold the array of lens cannot be used as a master form for making a mold according to the present invention to manufacture the array of lenses.

The present application describes a master form comprised of lens forms with cylindrical lateral walls disposed in generally cylindrical through holes of a support plate. Alternatively, at least a portion of the lateral walls of the lens forms and of the through holes may be conical to help aligning the lens forms and the holes.

FIG. 5 shows a master form where lens forms 56 are glued into position in through-holes 58. However, other appropriate means for maintaining the lens forms 56 in a desired position can be used, such as providing the top and bottom surfaces of plate 42 with stop plates having smaller through-holes, concentrically aligned with through-holes 58 and with a diameter too small to allow the lens forms 56 to move.

FIG. 7 shows upper and lower mold bases comprising alignment holes, holding upper and lower mold parts having no alignment holes. Alternatively, the upper and lower mold bases can be configured such that the upper and lower mold parts also have alignment holes. Such alignment holes of the upper and lower mold parts can be aligned with the alignment holes of the upper and lower mold bases or not. Such alignment holes of the upper and lower mold parts can be aligned with the alignment holes of the master form or not.

The mold of FIG. 8 allows manufacturing an all-resin lens array having alignment holes, but it can easily be adapted to manufacture an all-resin lens array having no alignment holes, for example by forming such array within a mold part substantially identical to the holder 91 shown in FIGS. 9A-B.

Reciprocally, FIGS. 9A-B illustrate the manufacturing of a lens array using a plate with no alignment holes placed in a support having alignment holes. Alternatively, a plate having alignment holes can be used instead of the plate with no alignment holes and support having alignment holes.

Manufacturing lens arrays with alignment holes advantageously allows aligning the lens arrays with other structures, such as spacers as shown in FIG. 10; sensor arrays and/or other lens arrays, for example for manufacturing a lens stack as shown in FIG. 1C.

The present application describes forming a mold by introducing a plastic in mold cavities. Alternative appropriate methods for forming a mold, such as pressing the master form into a soft material that is cured thereafter, or stamping a hard master form into a softer mold material, can be used if appropriate.

### Concepts

As short summaries, this writing has disclosed at least the following broad concepts.

Concept 1. A method of manufacturing an array of lenses; the array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned; the method comprising:

making a master form comprising:

a plate having a top surface and a bottom surface;

the top surface of the plate having a shape identical to the top surface of the array, including the top optical surface of each lens of the array; and

the bottom surface of the plate having a shape identical to the bottom surface of the array, including the bottom optical surface of each lens of the array; wherein

the parts of the top surface of the master form that are identical to the top optical surface of each lens of the array have first geometrical axes identical to the first optical axes, and the parts of the bottom surface of the master form that are identical to the bottom optical surface of each lens of the array have second geometrical axes identical to the second optical axes; the first and second geometrical axes being aligned; and

using the master form to produce a mold having a shape complementary to the shape of the array to be manufactured.

Concept 2. The method of concept 1, wherein using the master form to produce a mold comprises:

forming an upper mold part having a bottom surface with a shape that is complementary to the shape of the top surface of the master form; and

forming a lower mold part having a top surface with a shape that is complementary to the shape of the bottom surface of the master form.

Concept 3. The method of concept 2, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;

the method further comprising:

providing an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces;

such that the inner walls define, in combination with said groups of upper and lower lens molding surfaces, sub-molds capable of molding each a sub-array of lenses.

Concept 4. The method of concept 2, further comprising providing the upper mold part with first alignment holes and providing the lower mold part with second alignment holes; wherein:

forming a upper mold part having a bottom surface with a shape that is complementary to the shape of the top surface of the master form and forming a lower mold part having a top surface with a shape that is complementary to the shape of the bottom surface of the master form comprises aligning the first and second alignment holes.

Concept 5. The method of concept 4, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;

the method further comprising:

providing an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; such that the inner walls define, in combination with said groups of upper and lower lens molding surfaces, sub-molds capable of molding each a sub-array of lenses; and

providing the intermediary mold part with third alignment holes and aligning the third alignment holes with the first and second alignment holes.

Concept 6. The method of concept 2, further comprising providing the upper and lower mold parts with alignment means; wherein:

forming a upper mold part having a bottom surface with a shape that is complementary to the shape of the top surface of the master form and forming a lower mold part having a top surface with a shape that is complementary to the shape of the bottom surface of the master form comprises aligning the alignment means of the upper and lower mold parts.

Concept 7. A method of manufacturing an array of lenses; the array of lenses having a top surface and a bottom surface; each lens of the array having a top optical surface that forms part of the top surface of the array, and a bottom optical surface that forms part of the bottom surface of the array; the method comprising:

making a mold part comprising:

a plate having a top surface and a bottom surface;

the top surface of the plate having a shape complementary to the bottom surface of the array, including the bottom optical surface of each lens of the array; and

the bottom surface of the plate having a shape complementary to the top surface of the array including the top optical surface of each lens of the array; wherein

the parts of the top surface of the mold part that are complementary to the bottom optical surface of each lens of the array have first geometrical axes identical to the first optical axes, and the parts of the bottom surface of the mold part that are complementary to the top optical surface of each lens of the array have second geometrical axes identical to the second optical axes; the first and second geometrical axes being aligned.

Concept 8. A master form for manufacturing a mold for manufacturing an array of lenses; the array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned;

the master form comprising:

a plate having a top surface and a bottom surface;

the top surface of the plate having a shape identical to the top surface of the array, including the top optical surface of each lens of the array; and

the bottom surface of the plate having a shape identical to the bottom surface of the array, including the bottom optical surface of each lens of the array; wherein

the parts of the top surface of the master form that are identical to the top optical surface of each lens of the array have first geometrical axes identical to the first optical axes, and the parts of the bottom surface of the master form that are identical to the bottom optical surface of each lens of the array have second geometrical axes identical to the second optical axes; the first and second geometrical axes being aligned.

Concept 9. The master form of concept 8, wherein the master form is not transparent to light.

Concept 10. The master form of concept 8, wherein the array comprises lenses arranged along a two-dimensional pattern.

Concept 11. The master form of concept 8, wherein the plate further comprises alignment holes.

Concept 12. A mold manufactured using the master form of concept 8, comprising

an upper mold part having a bottom surface with a shape that is complementary to the shape of the top surface of the master form; and

a lower mold part having a top surface with a shape that is complementary to the shape of the bottom surface of the master form.

Concept 13. The mold of concept 12, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;

the mold further comprising:

an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; the inner walls being arranged to define, in combination with said groups of upper and lower lens molding surfaces, sub-molds capable of molding each a sub-array of lenses.

Concept 14. A mold manufactured using the master form of concept 11, comprising

an upper mold part having a bottom surface with a shape that is complementary to the shape of the top surface of the master form; and

a lower mold part having a top surface with a shape that is complementary to the shape of the bottom surface of the master form; wherein

the upper and lower mold parts comprise alignment holes that are aligned with the alignment holes of the master form.

Concept 15. The mold of concept 14, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;

the mold further comprising:

an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; the inner walls being arranged to define, in combination with said groups of upper and lower lens molding surfaces, sub-molds capable of molding each a sub-array of lenses; and

alignment holes capable of being aligned with the alignment holes of the upper and lower mold parts.

Concept 16. A mold manufactured using the master form of concept 8, comprising an upper mold part having a bottom surface with a shape that is complementary to the shape of the top surface of the lens array; the bottom surface of the upper mold part having upper negative lens shapes complementary to the top optical surface of each lens of the array; the upper negative lens shape having third geometrical axes identical to the first optical axes; and

a lower mold part having a top surface with a shape that is complementary to the shape of the bottom surface of the lens array; the top surface of the lower mold part having lower negative lens shapes complementary to the bottom optical surface of each lens of the array; the lower negative lens shape having fourth geometrical axes identical to the second optical axes; wherein

the upper and lower mold parts comprise alignment means for arranging the upper and lower mold parts with respect to each other such that the third and fourth geometrical axes are aligned.

Concept 17. A mold according to concept 16, wherein the master form comprises alignment means, and wherein the alignment means of the upper and lower mold parts cooperate with the alignment means of the master form for arranging the upper and lower mold parts with respect to the master form such that the first, second, third and fourth geometrical axes are aligned together.

Concept 18. A mold part for manufacturing an array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned;

the mold part comprising:

a plate having a top surface and a bottom surface;

the top surface of the plate having a shape complementary to the bottom surface of the array, including the bottom optical surface of each lens of the array; and

the bottom surface of the plate having a shape complementary to the top surface of the array including the top optical surface of each lens of the array; wherein

the parts of the top surface of the mold part that are complementary to the bottom optical surface of each lens of the array have first geometrical axes identical to the first optical axes, and the parts of the bottom surface of the mold part that are complementary to the top optical surface of each lens of the array have second geometrical axes identical to the second optical axes; the first and second geometrical axes being aligned.

1. A method of manufacturing an array of lenses; the array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned; the method comprising:
making a master form comprising:
a plate having a top surface and a bottom surface;
the top surface of the plate having a shape identical to the top surface of the array, including the top optical surface of each lens of the array; and
the bottom surface of the plate having a shape identical to the bottom surface of the array, including the bottom optical surface of each lens of the array; wherein
the parts of the top surface of the master form that are identical to the top optical surface of each lens of the array have first geometrical axes identical to the first optical axes, and the parts of the bottom surface of the master form that are identical to the bottom optical surface of each lens of the array have second geometrical axes identical to the second optical axes; the first and second geometrical axes being aligned; and
using the master form to produce a mold having a shape complementary to the shape of the array to be manufactured.

2. The method of claim 1, wherein using the master form to produce a mold comprises:
forming an upper mold part having a bottom surface with a shape that is complementary to the shape of the top surface of the master form; and
forming a lower mold part having a top surface with a shape that is complementary to the shape of the bottom surface of the master form.

3. The method of claim 2, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;
the method further comprising:
providing an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces;
such that the inner walls define, in combination with said groups of upper and lower lens molding surfaces, sub-molds capable of molding each a sub-array of lenses.

4. The method of claim 2, further comprising providing the upper mold part with first alignment holes and providing the lower mold part with second alignment holes; wherein:
forming a upper mold part having a bottom surface with a shape that is complementary to the shape of the top surface of the master form and forming a lower mold part having a top surface with a shape that is complementary to the shape of the bottom surface of the master form comprises aligning the first and second alignment holes.

5. The method of claim 4, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;
the method further comprising:
providing an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; such that the inner walls define, in combination with said groups of upper and lower lens molding surfaces, sub-molds capable of molding each a sub-array of lenses; and
providing the intermediary mold part with third alignment holes and aligning the third alignment holes with the first and second alignment holes.

6. The method of claim 2, further comprising providing the upper and lower mold parts with alignment means; wherein:
forming a upper mold part having a bottom surface with a shape that is complementary to the shape of the top surface of the master form and forming a lower mold part having a top surface with a shape that is complementary to the shape of the bottom surface of the master form comprises aligning the alignment means of the upper and lower mold parts.

7. A method of manufacturing an array of lenses; the array of lenses having a top surface and a bottom surface; each lens of the array having a top optical surface that forms part of the top surface of the array, and a bottom optical surface that forms part of the bottom surface of the array; the method comprising:
making a mold part comprising:
a plate having a top surface and a bottom surface;
the top surface of the plate having a shape complementary to the bottom surface of the array, including the bottom optical surface of each lens of the array; and
the bottom surface of the plate having a shape complementary to the top surface of the array including the top optical surface of each lens of the array; wherein
the parts of the top surface of the mold part that are complementary to the bottom optical surface of each lens of the array have first geometrical axes identical to the first optical axes, and the parts of the bottom surface of the mold part that are complementary to the top optical surface of each lens of the array have second geometrical axes identical to the second optical axes; the first and second geometrical axes being aligned.

8. A master form for manufacturing a mold for manufacturing an array of lenses; the array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned;
the master form comprising:
a plate having a top surface and a bottom surface;
the top surface of the plate having a shape identical to the top surface of the array, including the top optical surface of each lens of the array; and
the bottom surface of the plate having a shape identical to the bottom surface of the array, including the bottom optical surface of each lens of the array; wherein
the parts of the top surface of the master form that are identical to the top optical surface of each lens of the array have first geometrical axes identical to the first optical axes, and the parts of the bottom surface of the master form that are identical to the bottom optical surface of each lens of the array have second geometrical axes identical to the second optical axes; the first and second geometrical axes being aligned.

9. The master form of claim 8, wherein the master form is not transparent to light.

10. The master form of claim 8, wherein the array comprises lenses arranged along a two-dimensional pattern.

11. The master form of claim 8, wherein the plate further comprises alignment holes.

12. A mold manufactured using the master form of claim 8, comprising
an upper mold part having a bottom surface with a shape that is complementary to the shape of the top surface of the master form; and
a lower mold part having a top surface with a shape that is complementary to the shape of the bottom surface of the master form.

13. The mold of claim 12, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;
the mold further comprising:
an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; the inner walls being arranged to define, in combination with said groups of upper and lower lens molding surfaces, sub-molds capable of molding each a sub-array of lenses.

14. A mold manufactured using the master form of claim 11, comprising
an upper mold part having a bottom surface with a shape that is complementary to the shape of the top surface of the master form; and
a lower mold part having a top surface with a shape that is complementary to the shape of the bottom surface of the master form; wherein
the upper and lower mold parts comprise alignment holes that are aligned with the alignment holes of the master form.

15. The mold of claim 14, wherein the bottom surface of the upper mold part comprises upper lens molding surfaces that are complementary to the top optical surface of the lenses of the array and wherein the top surface of the lower mold part comprises lower lens molding surfaces that are complementary to the bottom optical surface of the lenses of the array;
the mold further comprising:
an intermediary mold part having inner walls capable of contacting the bottom surface of the upper mold part along predetermined perimeters between groups of upper lens molding surfaces; and capable of contacting the top surface of the lower mold part along predetermined perimeters between corresponding groups of lower lens molding surfaces; the inner walls being arranged to define, in combination with said groups of upper and lower lens molding surfaces, sub-molds capable of molding each a sub-array of lenses; and
alignment holes capable of being aligned with the alignment holes of the upper and lower mold parts.

16. A mold manufactured using the master form of claim 8, comprising
an upper mold part having a bottom surface with a shape that is complementary to the shape of the top surface of the lens array; the bottom surface of the upper mold part having upper negative lens shapes complementary to the top optical surface of each lens of the array; the upper negative lens shape having third geometrical axes identical to the first optical axes; and
a lower mold part having a top surface with a shape that is complementary to the shape of the bottom surface of the lens array; the top surface of the lower mold part having lower negative lens shapes complementary to the bottom optical surface of each lens of the array; the lower negative lens shape having fourth geometrical axes identical to the second optical axes; wherein
the upper and lower mold parts comprise alignment means for arranging the upper and lower mold parts with respect to each other such that the third and fourth geometrical axes are aligned.

17. A mold according to claim 16, wherein the master form comprises alignment means, and wherein the alignment means of the upper and lower mold parts cooperate with the alignment means of the master form for arranging the upper and lower mold parts with respect to the master form such that the first, second, third and fourth geometrical axes are aligned together.

18. A mold part for manufacturing an array of lenses having a top surface and a bottom surface; each lens of the array having a top optical surface that forms part of the top surface of the array, and a bottom optical surface that forms part of the bottom surface of the array; the top optical surface of each lens having a first optical axis and the bottom optical surface of each lens having a second optical axis, the first and second optical axis being aligned;
the mold part comprising:
a plate having a top surface and a bottom surface;
the top surface of the plate having a shape complementary to the bottom surface of the array, including the bottom optical surface of each lens of the array; and
the bottom surface of the plate having a shape complementary to the top surface of the array including the top optical surface of each lens of the array; wherein
the parts of the top surface of the mold part that are complementary to the bottom optical surface of each lens of the array have first geometrical axes identical to the first optical axes, and the parts of the bottom surface of the mold part that are complementary to the top optical surface of each lens of the array have second geometrical axes identical to the second optical axes; the first and second geometrical axes being aligned.
